(19) United States
(12) Patent Application Publication
(10) Pub. No.: US 2008/0236397 A1
(43) Pub. Date: Oct. 2, 2008

(54) Electronic Enclosure Filter for Very Small Spaces

(75) Inventor: Katsushi Isogawa, Eagan, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(73) Assignee: DONALDSON COMPANY, INC., Minneapolis, MN (US)

(21) Appl. No.: 12/115,164

(22) Filed: May 5, 2008

Related U.S. Application Data
(63) Continuation of application No. 11/179,788, filed on Jul. 11, 2005, now Pat. No. 7,367,997.
(60) Provisional application No. 60/632,753, filed on Dec. 1, 2004.
(60) Provisional application No. 60/587,631, filed on Jul. 12, 2004.

(51) Int. Cl. B03C 3/155

(52) U.S. Cl. 96/134

(57) ABSTRACT

The present invention is directed to an improved electronic enclosure filter for very small spaces, such as small disk drives. The filter includes an exposed electrostatic layer that functions to catch and retain particulate contamination within the filter. The filter can be placed within disk drive enclosures such that the electrostatic layer is in very close proximity to the rotating disk without causing excessive turbulence. The close proximity of the electrostatic to the disk creates relatively high levels of airflow over the electrostatic.

### PRIORITY

This application claims priority to U.S. application Ser. No. 11/179,788, filed on Jul. 11, 2005, which will issue on May 6, 2008 as U.S. Pat. No. 7,367,997. This application also claims priority to U.S. Provisional Application Ser. No. 60/632,753, filed Dec. 1, 2004 and 60/587,631, filed Jul. 12, 2004; the content of which are herein incorporated by reference.

### BACKGROUND

A need exists for improved filters for use in electronic enclosures. In particular, a need exists for improved filters for use in small electronic enclosures, such as the small disk drives used in personal media players, such as the Apple iPod.

### SUMMARY OF THE INVENTION

The present invention is directed to an improved electronic enclosure filter for very small spaces, such as small disk drives. The filter includes an exposed electrostatic layer that functions to catch and retain particulate contamination within the filter. The filter can be placed within disk drive enclosures such that the electrostatic layer is in very close proximity to the rotating disk without causing excessive turbulence. The close proximity of the electrostatic to the disk creates relatively high levels of airflow over the electrostatic.

Other features and advantages of the invention will be apparent from the following detailed description of the invention and the claims. The above summary of principles of the disclosure is not intended to describe each illustrated embodiment or every implementation of the present disclosure. The detailed description that follows more particularly exemplifies certain embodiments utilizing the principles disclosed herein.

### BRIEF DESCRIPTION OF THE DRAWING

The invention will be more fully explained with reference to the following drawings.

FIG. 1 is a cross section of a filter made in accordance with the present invention.

FIG. 2 is a plan view of a filter made in accordance with an embodiment of the invention.

While principles of the invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure and claims.

### DETAILED DESCRIPTION

Filters made in accordance with the present invention provide multiple functions in an adsorbent breather filter. Beside the standard functions of controlling passage of particulate contamination into the enclosure and control of chemical contaminants into and within said enclosure, this filter has added functionality of catching and holding particulate contamination that is present within the enclosure. As disk drives have become more miniaturized, the space allowed for filtration has been reduced significantly. As a result, new ways of performing some of the functions have been created to meet the ongoing needs for filtration with different filtration principles and constructions.

As noted above, the present invention includes an electrostatically charged filtration layer on the surface of an adsorbent breather filter which, when applied in the very small disk drives, will attract and hold particulate matter circulating in the drive. This invention is useful in smaller drives with smaller clearances that cause the air containing the particulate contaminant to come close enough for the electrostatic forces to capture them. The shape of flat adsorbent breather filter allows contaminated air to enter the zone where the electrostatic forces are stronger than the Newtonian forces propelling the particulate contamination.

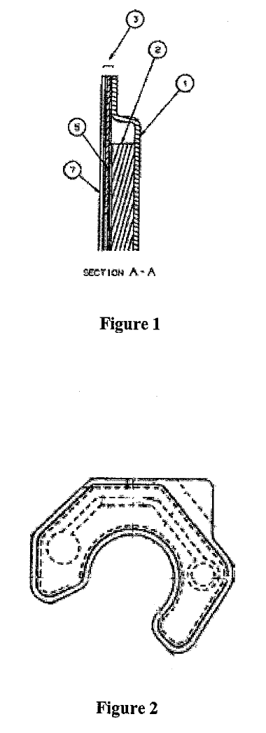

In reference now to FIG. 1, a cross section of a filter made in accordance with the present invention is shown. The outer layer 1 of the filter (exposed to the interior of the electronic enclosure) includes an electrostatic layer, and also generally contains a filter material (such as a PTFE membrane). An adsorbent material 2 is positioned inside the filter, and typically contains activated carbon. The bottom of the filter 3 typically includes a diffusion channel 5 and a release liner 7. A plan view of a filter made in accordance with the invention is shown in FIG. 2, showing the diffusion channel in the interior of the filter in dashed lines (because it is not visible from the exterior.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

We claim:

1. A filter for use in electronic enclosures, the filter comprising:
an adsorbent material;
an electrostatic material;
wherein the electrostatic material at least partially covers the adsorbent material; and
wherein the electrostatic material is configured to be exposed to the interior of the electronic enclosure.
